(19) United States
(12) Patent Application Publication
(10) Pub. No.: US 2026/0285333 A1
(43) Pub. Date: Sep. 24, 2026

(54) VEHICLE DIAGNOSTIC METHOD FOR INTELLIGENT SYSTEM ARCHITECTURE AND RELATED DEVICES

(71) Applicant: Launch Tech Co., Ltd., Shenzhen (CN)

(72) Inventors: Xin Liu, Shenzhen (CN); Guanchen Zhou, Shenzhen (CN)

(73) Assignee: Launch Tech Co., Ltd., Shenzhen (CN)

(21) Appl. No.: 19/342,008

(22) Filed: Sep. 26, 2025

Related U.S. Application Data
(63) Continuation of application No. PCT/CN2025/091681, filed on Apr. 28, 2025.

(30) Foreign Application Priority Data
Mar. 20, 2025 (CN) 202510335738.1

(51) Int. Cl. B60W 50/02; B60W 50/00; G06N 3/08

(52) U.S. Cl. CPC B60W 50/0205; G06N 3/08; B60W 2050/0031; B60W 2050/021; B60W 2556/10

(57) ABSTRACT

A vehicle diagnostic method for an intelligent system architecture and related devices are provided in the present application. The method includes: obtaining a target diagnostic requirement and historical diagnostic data of a target vehicle; annotating the historical diagnostic data according to a preset dictionary format, to obtain reference data; dividing, according to a preset ratio, the reference data into a training set and a validation set; obtaining a pre-trained model and model feature information of the pre-trained model; adjusting the pre-trained model according to the target diagnostic requirement, the model feature information, the training set, and the validation set, to obtain a target model; performing system construction according to the target model, to obtain a target diagnostic system; and diagnosing the target vehicle according to the target diagnostic system, to obtain a target diagnostic result.

### CROSS-REFERENCE TO RELATED APPLICATION(S)

This application is a continuation under 35 U.S.C. § 120 of International Patent Application No. PCT/CN2025/091681, filed Apr. 28, 2025, which claims priority under 35 U.S.C. § 119(a) and/or PCT Article 8 to Chinese Patent Application No. 202510335738.1, filed Mar. 20, 2025, the disclosures of both of which are hereby incorporated by reference in their entireties.

### TECHNICAL FIELD

This disclosure relates to the field of vehicle diagnostic technology, in particular to a vehicle diagnostic method for an intelligent system architecture and related devices.

### BACKGROUND

With the development of vehicle technology, especially the rise of new energy vehicles and intelligent connected vehicles, the field of vehicle diagnosis faces many challenges. Due to the rapid technological updates, the equipment and diagnostic technology need to be constantly updated to meet the technical characteristics of new vehicles. Meanwhile, the repair data and diagnostic codes of vehicle manufacturers are mostly proprietary, and it difficult for independent repair shops to obtain the latest repair information. In addition, diverse causes may lead to similar vehicle faults, which will greatly affect the diagnostic accuracy and efficiency.

Therefore, how to improve the accuracy and efficiency of vehicle diagnosis needs to be solved.

### SUMMARY

In a first aspect, embodiments of the present application provide a vehicle diagnostic method for an intelligent system architecture. The method includes: obtaining a target diagnostic requirement and historical diagnostic data of a target vehicle; annotating the historical diagnostic data according to a preset dictionary format, to obtain reference data; dividing, according to a preset ratio, the reference data into a training set and a validation set; obtaining a pre-trained model and model feature information of the pre-trained model; adjusting the pre-trained model according to the target diagnostic requirement, the model feature information, the training set, and the validation set, to obtain a target model; performing system construction according to the target model, to obtain a target diagnostic system; and diagnosing the target vehicle according to the target diagnostic system, to obtain a target diagnostic result.

In a second aspect, embodiments of the present application provide an electronic device. The electronic device includes at least one processor and a memory. The memory is coupled to the at least one processor and stores at least one computer executable instruction thereon. When executed by the at least one processor, the at least one computer executable instruction causes the at least one processor to execute steps of any method in the first aspect of embodiments of the present application.

In a third aspect, embodiments of the present application provide a non-transitory computer-readable storage medium. The computer-readable storage medium stores a computer program for electronic data exchange. The computer program causes a computer to execute part or all of steps described in any method of the first aspect of embodiments of the present application.

### BRIEF DESCRIPTION OF THE DRAWINGS

FIG. 1 is a system architecture diagram of a target diagnostic system provided in embodiments of the present application.

FIG. 2 is a schematic structural diagram of an electronic device provided in embodiments of the present application.

FIG. 3 is a schematic flow chart of a vehicle diagnostic method for an intelligent system architecture provided in embodiments of the present application.

FIG. 4 is a schematic flow chart of data annotation provided in embodiments of the present application.

FIG. 5 is a schematic flow chart of model adjustment provided in embodiments of the present application.

FIG. 6 is a flow chart of constructing a large model layer provided in embodiments of the present application.

FIG. 7 is an architecture diagram of a vehicle diagnostic scenario provided in embodiments of the present application.

FIG. 8 is a block diagram of functional modules of a vehicle diagnostic device for an intelligent system architecture provided in embodiments of the present application.

### DETAILED DESCRIPTION

To enable those of ordinary skill in the art to better understand the solution of the present application, the technical solution in the embodiments of the present application will be clearly and completely described below in conjunction with the drawings in the embodiments of the present application. Obviously, the described embodiments are only part of the embodiments of the present application, not all of the embodiments. Based on the embodiments in the present application, all other embodiments obtained by those of ordinary skill in the art without creative work are within the scope of protection of the present application.

It may be understood that, the terms “first”, “second”, and the like used in the specification and claims of embodiments of the present application are used to distinguish different objects rather than describe a particular order. In addition, the terms “include” and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

It should be understood that the term “and/or” herein merely describes an association relationship between associated objects, and indicates that there may be three relationships, for example, A and/or B may mean A alone, both A and B exist, and B alone. In addition, the character “/” herein indicates that the associated objects are in an “or” relationship. The “multiple” appearing in the embodiments of the present application refers to two or more.

In the embodiments of the present application, “at least one (item) of” or the like refers to any combination of these items, including any combination of a single one (item) or multiple items, and refers to one or more, where “multiple” refers to two or more. For example, at least one (item) of a, b, or c can represent the following seven cases: a; b; c; a and b; a and c; b and c; a, b, and c. a, b, and c each may be an element or a set including one or more elements.

The “connection” in embodiments of the present application refers to various connection methods, such as direct connection or indirect connection, to achieve communication between devices, which is not limited herein.

The term “embodiment” herein means that a particular feature, structure, or property described in conjunction with the embodiments may be contained in at least one embodiment of the present application. The phrase appearing in various places in the specification does not necessarily refer to the same embodiment, nor does it refer to an independent or alternative embodiment that is mutually exclusive with other embodiments. It is explicitly and implicitly understood by those of ordinary skill in the art that the embodiment described herein may be combined with other embodiments.

The following is an explanation of relevant terms involved in the present application. The explanation is as follows.

“Agent system” refers to a software system or entity with characteristics such as intelligence, autonomy, and interactivity, and is generally composed of one or more intelligent agents, where the agent can be software programs, hardware devices, or other entities with certain intelligent behaviors. The agent can perceive the information in the environment, make inferences and decisions based on its own goals and knowledge, and influence the environment by performing corresponding actions, to achieve specific tasks or goals.

With the development of vehicle technology, especially the rise of new energy vehicles and intelligent connected vehicles, the field of vehicle diagnosis faces many challenges. Due to the rapid technological updates, the equipment and diagnostic technology need to be constantly updated to meet the technical characteristics of new vehicles. Meanwhile, the repair data and diagnostic codes of vehicle manufacturers are mostly proprietary, and it difficult for independent repair shops to obtain the latest repair information. In addition, diverse causes may lead to similar vehicle faults, which will greatly affect the diagnostic accuracy and efficiency. Therefore, how to improve the accuracy and efficiency of vehicle diagnosis needs to be solved.

To solve the above problems, embodiments of the present application provide a vehicle diagnostic method for an intelligent system architecture and related devices. First, a target diagnostic requirement and historical diagnostic data of a target vehicle are obtained; the historical diagnostic data is annotated according to a preset dictionary format, to obtain reference data; according to a preset ratio, the reference data is divided into a training set and a validation set; a pre-trained model and model feature information of the pre-trained model are obtained; the pre-trained model is adjusted according to the target diagnostic requirement, the model feature information, the training set, and the validation set, to obtain a target model; system construction is performed according to the target model, to obtain a target diagnostic system; and the target vehicle is diagnosed according to the target diagnostic system, to obtain a target diagnostic result. By making targeted adjustments to a pre-trained model and constructing a target diagnostic system, a vehicle can be diagnosed accurately and efficiently, a reliable diagnostic result can be obtained, and intelligent and precise vehicle diagnosis can be achieved, thereby reducing the diagnostic cost and improving the diagnostic efficiency.

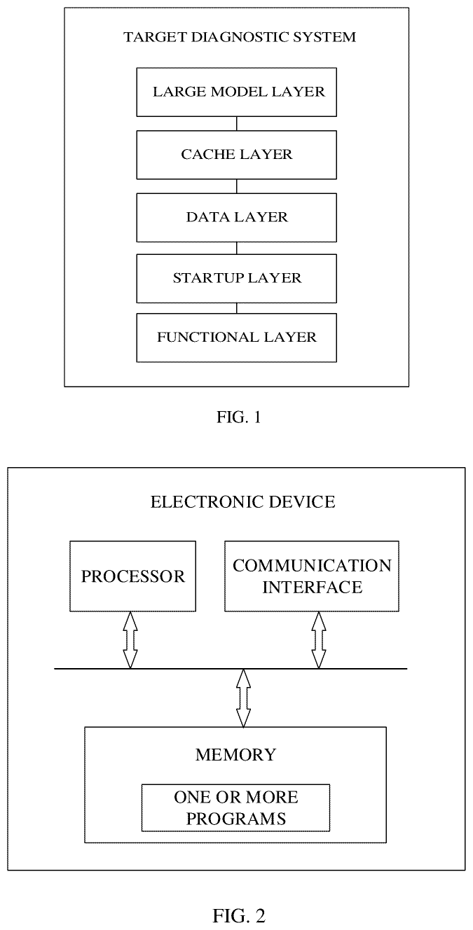

Referring to FIG. 1, FIG. 1 is a system architecture diagram of a target diagnostic system provided in embodiments of the present application. The target diagnostic system includes a large model layer, a cache layer, a data layer, a startup layer, and a functional layer. The target diagnostic system is an Agent system, which can handle a variety of different types of tasks, such as natural language processing, data analysis, code generation, and automated control. When processing decision-making tasks, it can efficiently evaluate various possibilities and select the best path.

The large model layer includes a pre-trained model(s) or other complex models, which can be deployed locally or accessed through the official interface of the large model, without specific limitation herein. The rich knowledge contained in the large model can be used to perform in-depth reasoning and analysis on relevant information of a target vehicle. For example, based on various phenomenon descriptions, sensor data, and the like at the time of vehicle fault, the possible cause and location of the fault can be inferred. The large model layer can automatically extract key features from a large amount of vehicle data, identify potential patterns in the data, and mine the complex associations between the data, to discover some fault signs or hidden dangers that are difficult to be directly detected through traditional methods. Based on the learning and reasoning capabilities of the model, it provides an intelligent decision-making basis for vehicle diagnosis, provides reasonable diagnostic suggestions and solutions for different vehicle status, and provides guidance for subsequent repairs and maintenance.

The cache layer is used to store frequently accessed data or calculation results. For example, the cache layer is used to store the chat cache information of each user and form a session cache file locally, which can be used to quickly load the historical information (or known as previous information) of each user, and can effectively improve the loading speed of the historical information, thereby quickly linking to the previous chat records, making the target diagnostic system have greater continuity. The cache layer can also store the recently used vehicle diagnostic data, the reasoning result of the large model, etc. When the same or similar data is needed again, it can be directly obtained from the cache, which greatly reduces the time for data reading and processing and improves the response speed of the system. As a temporary storage area in the data processing process, the cache layer facilitates the intermediate processing and conversion of data, provides convenience for subsequent analysis and calculation, and helps to improve the fluency and efficiency of data processing.

The data layer is responsible for storing and managing various data required by the system, including historical diagnostic data of the target vehicle, basic information of the vehicle, sensor data, etc. The data layer will integrate and pre-process data from different channels and in different formats, such as data cleaning, format conversion, standardization, etc., so that the data can meet the input requirement of the large model layer and the functional layer, and improve data quality and availability. The data layer is also responsible for security management of the data, and ensures the security and confidentiality of the data through access control, encryption and other technologies. Meanwhile, it backs up data to prevent data loss and ensure that data can be quickly restored when the system fails or data is damaged.

It should be noted that the content of the data layer is mainly stored through the Mysql database, and the stored table content includes, but is not limited to, the user basic information table, chat record table, knowledge base file conversation record table, and session record table, which is not specifically limited herein. The user basic information table includes the registered username, password, and user ID of the user. The chat record table includes the chat record ID, session ID, chat type, user question, and model answer. The knowledge base file conversation record table includes the knowledge file ID, file name, name of associated knowledge base, document loader name, text splitter name, file modification time, file type, file size, number of split documents, and creation time. The session record table includes the session ID, user ID, dialog name, chat type, and creation time, which is not specifically limited herein.

The startup layer is responsible for the initialization and startup of the system, including loading the necessary configuration file, initializing the large model, establishing connections with other layers, and other operations. The startup layer ensures that each component can be correctly loaded and run when the system starts, preparing for the normal work of the system. The startup layer can also coordinate the allocation of the hardware resources of the system, such as CPU, memory, storage, etc., and reasonably schedule computing resources, to ensure that the large model layer, functional layer, etc. can run efficiently with sufficient resources, avoiding resource conflicts and waste. The startup layer can start various services required by the system, such as data services, model services, etc., and monitor the startup status of these services in real time, promptly discover and handle problems that arise in the startup process, and ensure the stable startup and operation of the system.

It should be noted that the startup layer can be started through the FastAPI framework, which is not specifically limited herein. The framework can quickly and conveniently provide interfaces for external use, to facilitate invoking from other systems or clients, promote integration and interaction between systems, and enhance the openness and scalability of the system. The framework can asynchronously process the running logic of the project, to avoid thread blocking, make full use of system resources, improve the overall performance and response speed of the system, and enable the system to keep stable operation even under high concurrency conditions. The framework has the function of managing different processes, and can effectively organize and coordinate the various components and tasks within the system. The framework can simultaneously start multiple interfaces for external access, to meet the needs of different clients for invoking different functions of the system. The client includes, but is not limited to, mobile clients, network clients, and vehicle-mounted clients, which is not specifically limited herein.

The functional layer is used to implement various specific functions of the system, such as user management, session management, knowledge base management, database management, and tool block management. The user management is used to manage and store registration information, session information, etc. of the user, and save the relevant information as various data tables of the data layer for storage. The session management is used to manage sessions of the user, including session creation, maintenance, termination, etc., and can track user operation processes and interaction history, save the session status information and manage and store the information. The knowledge base management is used to maintain and update the knowledge base of the system, including entry, review, classification, retrieval, and other operations of the knowledge, and import it into a vector database. The database management is used to manage vector databases and Mysql databases, including storage, backup, recovery, optimization, and other operations of the database. When the user selects different vector databases, the process is recorded and stored in the Mysql database. The tool block management is used to add tool classes used by management agents, where the tool class includes, but not limited to, optical character recognition (OCR) functions, text processing functions, search engine modules, which can automatically select tools suitable for user questions according to user intentions, and record the process of each question and answer into the Mysql database.

It can be seen that by constructing the target diagnostic system, the user is provided with the ability of automated processing and natural language interaction, which can troubleshoot the fault of the system efficiently and accurately, improve work efficiency and user experience, achieve intelligent and precise vehicle diagnosis, and reduce diagnostic cost and improves diagnostic efficiency.

The electronic device in embodiments of the present application is described below in conjunction with FIG. 2. FIG. 2 is a schematic structural diagram of an electronic device provided in embodiments of the present application. As shown in FIG. 2, the electronic device includes one or more processors, a memory, a communication interface, and one or more programs. The processor is communicatively connected to the memory and the communication interface through an internal communication bus.

The processor is mainly configured to: obtain a target diagnostic requirement and historical diagnostic data of a target vehicle; annotate the historical diagnostic data according to a preset dictionary format, to obtain reference data; divide, according to a preset ratio, the reference data into a training set and a validation set; obtain a pre-trained model and model feature information of the pre-trained model; adjust the pre-trained model according to the target diagnostic requirement, the model feature information, the training set, and the validation set, to obtain a target model; perform system construction according to the target model, to obtain a target diagnostic system; and diagnose the target vehicle according to the target diagnostic system, to obtain a target diagnostic result.

The one or more programs are stored in the above-mentioned memory and are configured to be executed by the above-mentioned processor. The one or more programs include instructions for executing any step in the above-mentioned method embodiment.

The processor can be, for example, a central processing unit (CPU), a general processor, a digital signal processor (DSP), an application-specific integrated circuit (ASIC), a field programmable gate array (FPGA) or other programmable logic devices, transistor logic devices, hardware components or any combination thereof. The processor can implement or execute various exemplary logic blocks, units, and circuits described in conjunction with the present application of the present application. The processor can also be a combination that implements a computing function, such as a combination of one or more microprocessors, a combination of a DSP and a microprocessor, and the like. The communication unit can be a communication interface, a transceiver, a transceiver circuit, and the like, and the storage unit can be a memory.

The memory may be a volatile memory or a nonvolatile memory, or may include both volatile and nonvolatile memories. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of illustrative rather than limiting description, many forms of random access memory (RAM) are available, such as static RAM (SRAM), dynamic random access memory (DRAM), synchronous DRAM (SDRAM), double data rate SDRAM (DDR SDRAM), enhanced SDRAM (ESDRAM), synchronous link DRAM (SLDRAM), and direct rambus RAM (DR RAM).

It is understandable that the electronic device may include more or fewer structural elements than those in the above structural block diagram, for example, including a power module, physical buttons, a Wi-Fi module, a speaker, a Bluetooth module, a sensor, a display module, etc., which is not limited herein. It is understandable that the electronic device may be equipped with the system architecture described in FIG. 1.

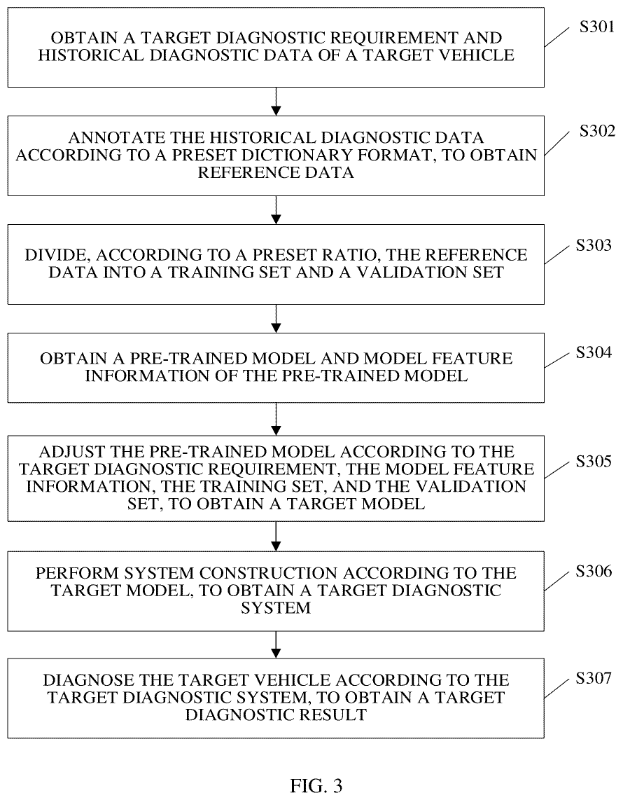

After understanding the software and hardware architecture of the present application, a vehicle diagnostic method for an intelligent system architecture in embodiments of the present application is described below in conjunction with FIG. 3. FIG. 3 is a flow chart of a vehicle diagnostic method for an intelligent system architecture provided in embodiments of the present application. The method includes the following.

S301, a target diagnostic requirement and historical diagnostic data of a target vehicle are obtained.

Specifically, the target diagnostic requirement of a user for the target vehicle can be obtained through the client, such as the fault occurred in the target vehicle, the component or system that need to be detected in the target vehicle, etc. The default target diagnostic requirement can also be automatically generated according to the type, model, service life, and other information of the target vehicle. For example, for vehicles with a long service life, the system may automatically determine detections such as engine aging, component wear, and other aspects as the target diagnostic requirement. The system can also automatically identify possible problems and diagnostic items that need to be performed based on the real-time operation data and historical fault records of the target vehicle and intelligent analysis of the large model layer. For example, when the fuel consumption of the target vehicle suddenly increases, the system will determine the fuel system, engine combustion conditions, etc. as the target diagnostic requirement. In addition, the historical diagnostic data such as historical diagnostic reports, fault records, and detection data of the target vehicle can be retrieved from the database, and recent historical diagnostic data of the target vehicle can also be quickly loaded through the stored historical cache file, which is not specifically limited herein.

It can be seen that by clarifying the target diagnostic requirement and the historical diagnostic data, unnecessary or repetitive work can be avoided, thereby saving vehicle diagnostic time and improving diagnostic efficiency.

S302, the historical diagnostic data is annotated according to a preset dictionary format, to obtain reference data.

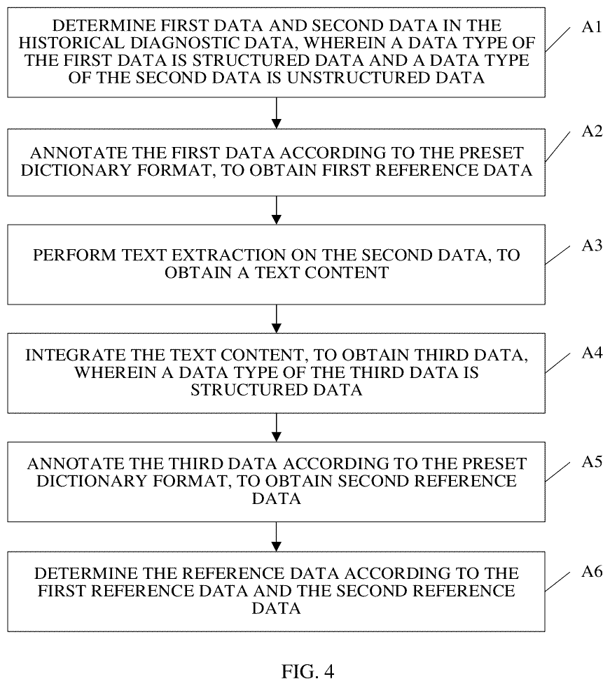

For ease of understanding, referring to FIG. 4, FIG. 4 is a schematic flow chart of data annotation provided in embodiments of the present application. The data annotation includes the following.
A1, first data and second data in the historical diagnostic data are determined, where a data type of the first data is structured data and a data type of the second data is unstructured data.
A2, the first data is annotated according to the preset dictionary format, to obtain first reference data.
A3, text extraction is performed on the second data, to obtain a text content.
A4, the text content is integrated, to obtain third data, where a data type of the third data is structured data.
A5, the third data is annotated according to the preset dictionary format, to obtain second reference data.
A6, the reference data is determined according to the first reference data and the second reference data.

In a specific embodiment, first, the historical diagnostic data is divided into the first data and the second data. The data type of the first data is structured data, for example, vehicle fault codes and sensor values stored in a table format. The data type of the second data is unstructured data, for example, text descriptions of repair records, text information of user feedback, images related to vehicle diagnostic, etc. Then, the first data is annotated according to the preset dictionary format to obtain first reference data.

Next, text extraction is performed on the second data to obtain the text content. The text content corresponding to the second data can be extracted by using the OCR technology, which is not specifically limited herein. The text content is then integrated into the structured third data. The natural language processing technology can be used to extract the key entity information from the text content, and then the extracted key entity information is classified according to predefined categories or templates, and then the information under each category is annotated to specify the exact field to which it belongs, and finally, the classified and annotated information is organized into structured third data.

Then, the third data is annotated according to the dictionary format to obtain the second reference data. Finally, the reference data is determined based on the first reference data and the second reference data. It should be noted that the dictionary format refers to a structure or rule for standardizing and normalizing data annotation. The data can be stored in the form of key-value pairs, where each key corresponds to a specific data item and the value is the specific content of the data item. The data can also be stored in the form of a table, containing multiple columns and rows, where each column represents a specific data attribute and each row corresponds to a specific data instance. The data can also be stored in a tree or hierarchical structure. For example, in vehicle diagnosis, the various systems of the target vehicle can be used as top-level nodes, and each system contains multiple subsystems and components. Each component corresponds to relevant diagnostic data, which is not specifically limited herein.

It can be seen that by converting different types of data into a unified and standardized format through classification and annotating, the quality and availability of the data can be improved, and the speed and efficiency of data retrieval can be further improved.

S303, the reference data is divided into a training set and a validation set according to a preset ratio.

Specifically, the preset ratio can be 7:3 or 8:2, which is not specifically limited herein. First, the corresponding preset ratio can be selected according to the amount of the data and the complexity of the problem. If the amount of data is small, the proportion of the training set can be appropriately increased, to ensure that the model can learn enough features; if the amount of data is large, the proportion of the training set can be appropriately reduced while the training effect of the model and the effectiveness of verification can be ensured. Then, the reference data is randomly divided into the training set and the validation set according to the preset ratio. For example, 70% of the reference data is the training set and 30% of the reference data is the validation set. It should be noted that to ensure the model performance of the model, the reference data can also be divided into a training set, a validation set, and a test set according to a specific ratio, and after the model training and verification are completed, the model performance of the model is finally evaluated through the test set.

It can be seen that by reasonably dividing the reference data into the training set and the validation set, a reliable data basis can be provided for training and evaluation of the model, helping to select the appropriate model and adjust the model parameter, thereby improving the performance and generalization ability of the model in practical application.

S304, a pre-trained model and model feature information of the pre-trained model are obtained.

Specifically, the corresponding pre-trained model can be obtained through an open source model library or a model provider. Then, its model feature information can be determined through the relevant documents of the pre-trained model, such as the model architecture, input and output format requirement, parameter type, etc., which is not specifically limited herein.

S305, the pre-trained model is adjusted according to the target diagnostic requirement, the model feature information, the training set, and the validation set, to obtain a target model.

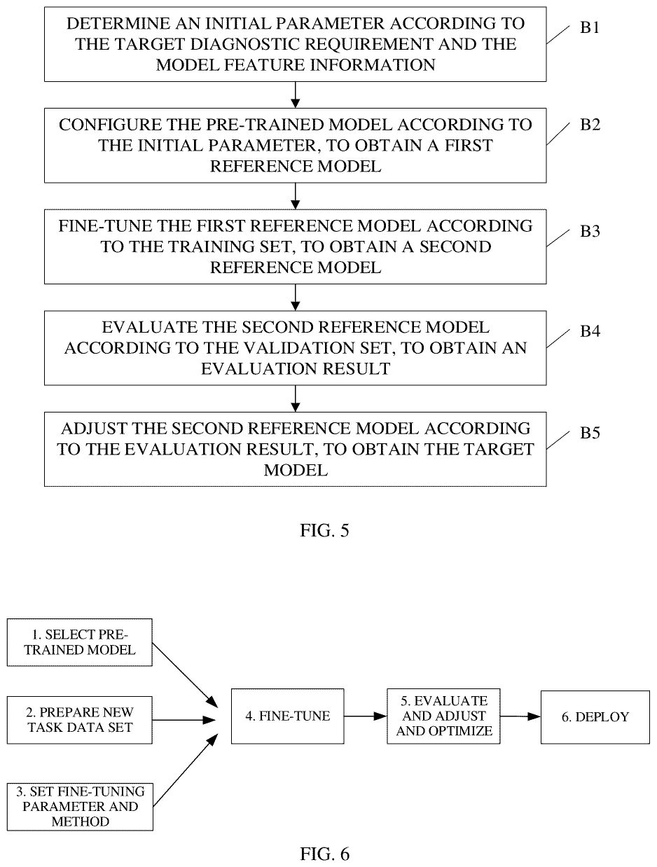

For ease of understanding, referring to FIG. 5, FIG. 5 is a schematic flow chart of model adjustment provided in embodiments of the present application. The model adjustment includes the following.
B1, an initial parameter is determined according to the target diagnostic requirement and the model feature information.
B2, the pre-trained model is configured according to the initial parameter, to obtain a first reference model.
B3, the first reference model is fine-tuned according to the training set, to obtain a second reference model.
B4, the second reference model is evaluated according to the validation set, to obtain an evaluation result.
B5, the second reference model is adjusted according to the evaluation result, to obtain the target model.

In a specific embodiment, first, the initial parameter of the pre-trained model is determined by analyzing the target diagnostic requirement and the model feature information. Then, the pre-trained model is configured according to the initial parameter, to obtain the first reference model. Then, the first reference model is fine-tuned according to the training set, to obtain the second reference model. The second reference model is evaluated according to the validation set to obtain the evaluation result. Finally, the second reference model is adjusted according to the evaluation result to obtain the target model.

The initial parameter is determined according to the target diagnostic requirement and the model feature information as follows.
C1, a diagnostic task type and a diagnostic task difficulty that correspond to the target diagnostic requirement are determined.
C2, a basic structure and an initial performance of the pre-trained model are determined according to the model feature information.
C3, a part of structure corresponding to the diagnostic task type in the basic structure is determined, to obtain a reference structure.
C4, a first parameter corresponding to the reference structure is determined.
C5, a second parameter of the pre-trained model is determined according to the diagnostic task difficulty and the initial performance.
C6, the initial parameter is determined according to the first parameter and the second parameter.

In a specific embodiment, first, the diagnostic task type and the diagnostic task difficulty corresponding to the target diagnostic requirement are determined, where the diagnostic task type includes, but is not limited to, fault classification, fault prediction, and fault cause analysis, which is not specifically limited herein. The diagnostic task difficulty (understood as the difficulty of the diagnostic task) is comprehensively determined by many factors, such as the complexity of the data, the degree of abstraction of the task, the amount of information that can be obtained, etc. For rare vehicle faults, the diagnostic task difficulty will be greater due to the small amount of relevant data. Then, the basic structure and initial performance of the pre-trained model are determined based on the model feature information, where the model feature information includes the basic structure of the pre-trained model, such as the number of layers contained in the neural network model, the number of neurons in each layer, and the connection manner between layers. The initial performance of the pre-trained model can be determined by looking at the evaluation indicators used by the pre-trained model in the pre-training stage, such as accuracy rate, recall, mean square error, etc. For example, if the accuracy rate of a pre-trained text classification model on its pre-training data set is 80%, then this result is its initial performance.

Next, the part of structure corresponding to the diagnostic task type in the basic structure is determined to obtain the reference structure. Different diagnostic task types may only be related to a part of the basic structure of the pre-trained model. For example, for a vehicle fault classification task, if the pre-trained model is a general deep learning model, focus on the output layer and a part of hidden layers directly connected to the output layer of the model, where this part is mainly responsible for making decisions on classification of the input information. This part of structure corresponding to the diagnostic task type is extracted to obtain the reference structure. Then, the first parameter corresponding to the reference structure is determined. The first parameter can be the connection weight between neurons, bias, etc., which is not specifically limited herein.

Finally, the second parameter of the pre-trained model is determined according to the diagnostic task difficulty and the initial performance, where the second parameter includes hyperparameters related to the training process, such as learning rate, number of training rounds, batch size, etc. If the diagnostic task is difficult and the initial performance of the pre-trained model is average, it may be necessary to appropriately reduce the learning rate and increase the number of training rounds, to allow the model have more time and a more stable learning process to adapt to the task. For example, for the complex vehicle fault prediction task, the learning rate may be set to a smaller value, such as 0.001, and the number of training rounds may be increased to 100 rounds. The first parameter and the second parameter are then combined to obtain the initial parameter.

It can be seen that by comprehensively considering the target diagnostic requirement and the characteristics of the pre-trained model, the initial parameter in the field of vehicle diagnosis can be determined scientifically and rationally, laying the foundation for subsequent model optimization and accurate diagnosis.

The training set includes n training subsets, where n is an integer greater than 1, and the first reference model is fine-tuned according to the training set to obtain the second reference model as follows.
D1, a first training subset is obtained, where the first training subset is any one of the n training subsets.
D2, the first training subset is input into the first reference model, to obtain a first output result.
D3, a first loss function is determined according to the diagnostic task type.
D4, a first true result corresponding to the first output result is determined.
D5, a loss value between the first output result and the first true result is calculated according to the first loss function, to obtain a first loss value.
D6, a first gradient corresponding to the first loss value is determined.
D7, the initial parameter is adjusted according to the first gradient, to obtain a first fine-tuning parameter.
D8, the first reference model is fine-tuned according to the first fine-tuning parameter, to obtain a first fine-tuned model.
D9, whether the first fine-tuned model meets a preset condition is determined.
D10, when the first fine-tuned model meets the preset condition, the first fine-tuned model is determined as the second reference model.
D11, when the first fine-tuned model fails to meet the preset condition, the first fine-tuned model is fine-tuned according to (n-1) training subsets among the n training subsets except the first training subset, to obtain the second reference model.

In a specific embodiment, first, to improve the training efficiency and effect, the training set is divided into the n training subsets, and then one of the training subsets is randomly selected as the first training subset, facilitating to train in batches the first reference model according to each training subset, so that the first reference model can gradually learn the features and laws in the data. Then, the data in the first training subset is input into the first reference model, and the first reference model will calculate and process the input data according to its internal parameters and structure, and finally output the prediction result, that is, the first output result. For example, in a vehicle fault classification task, after the fault feature data of the vehicle is input, the first reference model outputs the prediction result of the fault type.

Next, the first loss function is determined according to the diagnostic task type, where different diagnostic task types require different loss functions. For example, for classification tasks, such as determining the fault type of the vehicle, the corresponding first loss function may be a cross entropy loss function; for regression tasks, such as predicting the time when a vehicle fault occurs, the corresponding first loss function may be a mean square error loss function. Then, the first true result corresponding to the first output result is determined. The first output result and the first true result are substituted into the first loss function for calculation, to obtain the first loss value. The first loss value reflects the prediction error of the first reference model on the first training subset. The smaller the first loss value, the closer the prediction result of the first reference model is to the true result, and the better the performance of the first reference model.

Then, the first gradient corresponding to the first loss value is calculated, and the first gradient represents the rate of change and direction of change of the first loss function under the initial parameter. Thereafter, according to the calculated first gradient, the initial parameter is adjusted using a preset optimization algorithm, to obtain the first fine-tuning parameter. Through the optimization algorithm, the initial parameter of the first reference model will be updated with a specific step size according to the direction and magnitude of the first gradient, to obtain the first fine-tuning parameter. For example, when the optimization algorithm is a stochastic gradient descent algorithm, the product of the first gradient and the learning rate can be subtracted from the initial parameter, so that the first loss value is gradually reduced. The first fine-tuning parameter is applied to the first reference model, and the parameter of the first reference model is updated to obtain the first fine-tuned model.

Finally, determine whether the first fine-tuned model meets the preset condition. The preset condition can be set according to actual needs, for example, the loss value being less than a specific threshold, the accuracy rate reaching a specific level, etc., which is not specifically limited herein. If the first fine-tuned model meets the preset condition, which means that the first fine-tuned model has achieved the expected performance under the current training, it can be determined as the second reference model and the validation set can be used to evaluate it in the future. If the first fine-tuned model does not meet the preset condition, it means that the first fine-tuned model needs further training. In this case, (n-1) training subsets other than the first training subset are used to continue fine-tuning the first fine-tuned model, the above steps are repeated until the model meets the preset condition, and finally the second reference model is obtained.

It can be seen that by continuously adjusting the model parameters and gradually adapting the model to the training data related to vehicle diagnosis, the reasoning speed and execution efficiency of the model can be improved.

The second reference model is adjusted according to the evaluation result to obtain the target model as follows.
E1, an evaluation indicator and an evaluation value that correspond to the evaluation result are determined.
E2, a reference value range and a third parameter that correspond to the evaluation indicator are determined.
E3, when the evaluation value is within the reference value range, the second reference model is determined as the target model.
E4, when the evaluation value is beyond the reference value range, a maximum value and a minimum value of the reference value range are determined.
E5, a difference between the evaluation value and the maximum value or the minimum value is calculated, to obtain a first difference.
E6, an adjustment factor corresponding to the first difference is determined.
E7, the third parameter is adjusted according to the adjustment factor, to obtain a fourth parameter.
E8, the second reference model is adjusted according to the fourth parameter to obtain the target model.

In a specific embodiment, first, after the second reference model is evaluated using the validation set, the corresponding evaluation result is obtained, and then the evaluation indicator and evaluation value corresponding to the evaluation result are determined. The evaluation indicator is a specific standard for measuring the model performance. For example, in the classification task of vehicle fault diagnosis, the evaluation indicator can be the accuracy rate, which is used to indicate the proportion of the number of correctly predicted samples to the total number of samples. Alternatively, the evaluation indicator can be the recall rate, which is used to indicate the proportion of samples that are correctly predicted as positive examples among actual positive examples, which is not specifically limited herein. The evaluation value is the specific value calculated for the evaluation indicator by the second reference model on the validation set, such as the accuracy rate of 0.85. Then, the reference value range and the third parameter corresponding to the evaluation indicator are determined. The reference value range can be determined based on actual experience, professional field knowledge, or previous experimental results. For example, for the accuracy rate of the vehicle fault diagnostic model, the corresponding reference value range may be set to 0.8-0.95. The third parameter is a hyperparameter related to the model, such as a learning rate, a regularization parameter, etc. The third parameter will affect the training and performance of the second reference model.

Next, when the evaluation value is within the reference value range, which means that the performance of the second reference model has reached the expected standard and no further adjustment is required, the second reference model can be determined as the final target model. When the evaluation value is not within the reference value range, which means that the performance of the second reference model has not reached the ideal state and the second reference model needs to be adjusted, the maximum and minimum values of the reference value range are determined. Then, the difference between the evaluation value and the maximum or minimum value is calculated to obtain the first difference. If the evaluation value is less than the minimum value, the first difference is calculated between the evaluation value and the minimum value; if the evaluation value is greater than the maximum value, the first difference is calculated between the evaluation value and the maximum value. According to the mapping relationship between the first difference and the adjustment factor, the adjustment factor corresponding to the first difference is determined. The larger the first difference, the larger the adjustment factor is, to adjust the model parameters to a greater extent. Then, the third parameter is adjusted according to the adjustment factor to obtain the fourth parameter. Finally, the fourth parameter is applied to the second reference model, and the second reference model is adjusted accordingly to obtain the target model.

It can be seen that according to the evaluation result of the model on the validation set, the model can be adjusted and optimized in a targeted manner, to obtain the target model with better performance, improving the diagnostic accuracy and reliability of the model in practical applications.

S306, system construction is performed according to the target model, to obtain a target diagnostic system.

The system construction is performed according to the target model to obtain the target diagnostic system as follows.
F1, a hardware facility corresponding to the target model is determined.
F2, a deep learning framework compatible with the hardware facility is determined.
F3, the target model is deployed according to the deep learning framework, to obtain a large model layer.
F4, the reference data is integrated, to obtain a data layer.
F5, a cache layer, a startup layer, and a functional layer that are preset are obtained, where the cache layer is used to store cache information, the startup layer is used to provide a system interface, and the functional layer includes a user management module, a session management module, a knowledge base management module, a database management module, and a tool block management module.
F6, system construction is performed according to the large model layer, the data layer, the cache layer, the startup layer, and the functional layer, to obtain the target diagnostic system.

In a specific embodiment, first, the corresponding hardware facility is determined according to the target model, where target models of different types and scales require different hardware resources and correspond different hardware facilities. Then, the deep learning framework compatible with this hardware facility is selected, and the target model is deployed to the corresponding hardware facility through the deep learning framework, to obtain the large model layer. The model deployment process includes loading the parameters, structure, and other information of the target model into the hardware facility, and performing necessary configuration and optimization, so that it can efficiently perform reasoning and calculation in the actual operation environment. Then, the reference data is integrated, and the reference data is reasonably organized and indexed to form the data layer, so that the large model layer can read and use the data quickly and accurately.

Next, the pre-set cache layer, startup layer, and functional layer are obtained. The cache layer is used to store cache information, such as the chat cache information of the user, the intermediate calculation result of the model, etc. The cache layer can improve the response speed of the system and reduce the repeated calculation and reading of data. For example, the chat records between the user and the system are cached, when the user requests relevant information again, it can be directly obtained from the cache layer without re-querying the database or performing complex calculations. The startup layer is used to provide a system interface, which can be implemented through tools such as the FastAPI framework. The startup layer is responsible for the initialization, resource allocation, and scheduling of the system, and can provide various interfaces to the outside, to facilitate other systems or users to interact with the target diagnostic system. For example, through the interface provided by the startup layer, the user can send the vehicle diagnostic request and obtain the diagnostic result. The functional layer includes the user management module, the session management module, the knowledge base management module, the database management module, and the tool block management module. The user management module is responsible for user registration, login, permission management, etc. The session management module is used to manage the session between the user and the system. The knowledge base management module is used to maintain the knowledge base of the system. The database management module is used to manage the data layer. The tool block management module is used to manage various intelligent tool blocks in the system. The various functional modules of the functional layer cooperate to achieve the various specific functions of the system.

Finally, the large model layer, data layer, cache layer, startup layer, and functional layer are integrated and connected to construct the complete target diagnostic system. Each layer interacts through interfaces and data transmission. The large model layer obtains data from the data layer for reasoning and calculation, and returns the result to the user or other modules. The cache layer provides data caching and acceleration functions for the system. The startup layer is responsible for system startup and interface provision. The functional layer implements various specific functions of the system. Through the cooperation of various layers, the complete and efficient target diagnostic system can be formed, to meet the needs of practical applications such as vehicle diagnosis.

It can be seen that by constructing a multimodal target diagnostic system, the system can accurately perform tasks such as vehicle diagnosis, and have good scalability and maintainability, adapt to changing service needs and data characteristics, and provide reliable support for practical applications.

S307, the target vehicle is diagnosed according to the target diagnostic system, to obtain a target diagnostic result.

Specifically, the target diagnostic system will first obtain relevant data from the target vehicle. The relevant data includes the operation data transmitted in real time by various sensors of the target vehicle, such as the operation data corresponding to the engine temperature sensor, speed sensor, oil pressure sensor, etc., as well as the historical repair records and maintenance information of the vehicle. After the relevant data is collected, it is properly pre-processed, such as data cleaning and format conversion, and then input into the data layer of the target diagnostic system for storage and management. For example, the sensor data of the target vehicle is sent to the target diagnostic system in real time at a certain frequency. The target diagnostic system will check the integrity and accuracy of the sensor data, and store it in the database after removing the outliers. Then, the relevant data in the data layer will be transmitted to the large model layer. The target model in the large model layer is obtained through training, adjustment, and deployment. The target model has the ability to analyze and diagnose the vehicle fault. The target model can use its learned features and patterns to perform inference calculations based on the input data. For example, for the input engine operation data, the target model will compare it with the normal operation mode and fault mode learned in the training process, to determine whether an abnormality exists and the possible fault type.

For ease of understanding, referring to FIG. 6, FIG. 6 is a flow chart of constructing a large model layer provided in embodiments of the present application. It can be seen that the pre-trained model is selected first, and the pre-trained model is a model that has been pre-trained on the large-scale data set, such as Baichuan, Qwen, ChatGLM, and other models, which is not specifically limited herein. Then, a data set related to a specific task is collected and processed, to obtain a new task data set. According to the task property and model characteristics, appropriate fine-tuning parameters such as learning rate, batch size, training rounds, etc. are set. Then, the pre-trained model is further trained on the new task data set, and the performance of the model on the new task is optimized by adjusting the model weights and parameters. The fine-tuned model is then evaluated using the validation set corresponding to the new task data set, and the model structure and parameters are adjusted according to the evaluation result until satisfactory performance is achieved. Finally, the fine-tuned model is deployed in a practical application scenario, that is, in the large model layer in the target diagnostic system, to achieve the practical value of the model. The large model layer can perform knowledge content questions and answers in the field of vehicle diagnosis, and the large model layer can be privately deployed to avoid uploading sensitive data to the cloud, thereby ensuring data security and privacy.

Then, in the reasoning process of the large model layer, the various functional modules of the functional layer will provide corresponding support. For example, the user management module can ensure that only the authorized user can access the diagnostic result, thereby ensuring the security and privacy of the data. The session management module can maintain the interactive session between the user and the system, record the operation and request history of the user, and facilitate the user to view and track the diagnostic process at any time. The knowledge base management module can provide relevant knowledge and experience support for the large model layer. For example, when the target model encounters an uncertain situation during diagnosis, it can obtain knowledge about the vehicle model, fault type, etc. from the knowledge base to assist the target model in making more accurate decisions. The database management module is responsible for managing and maintaining the data in the data layer, ensuring reliable storage and rapid retrieval of data, and providing accurate data support for the large model layer and other modules. The tool block management module can provide various data analysis and processing tools, to help the large model layer process data more effectively. For example, the data visualization tool is used to display the vehicle data in the form of charts, which is convenient for the user to intuitively understand the operation status of the target vehicle. If similar data or calculation results have been processed in previous diagnoses, the relevant information will be stored in the cache layer. When encountering the same or similar situation again, the system can directly obtain relevant information from the cache layer, to avoid repeated calculations and speed up diagnosis.

Finally, after inference calculation, the large model layer will generate the target diagnostic result for the target vehicle. The target diagnostic result may include whether the target vehicle has a fault, the type of fault, the severity of the fault, the possible cause of the fault, and the corresponding repair suggestions, etc., which is not specifically limited herein. The target diagnostic result will be fed back to the user through the interface provided by the startup layer, and the user can view the detailed diagnostic report through the client.

It can be seen that through the cooperative work of various layers of the target diagnostic system, from data collection to the output of the final diagnostic result, comprehensive, accurate, and efficient diagnosis of the target vehicle can be achieved, providing strong support for the maintenance and repair of the vehicle.

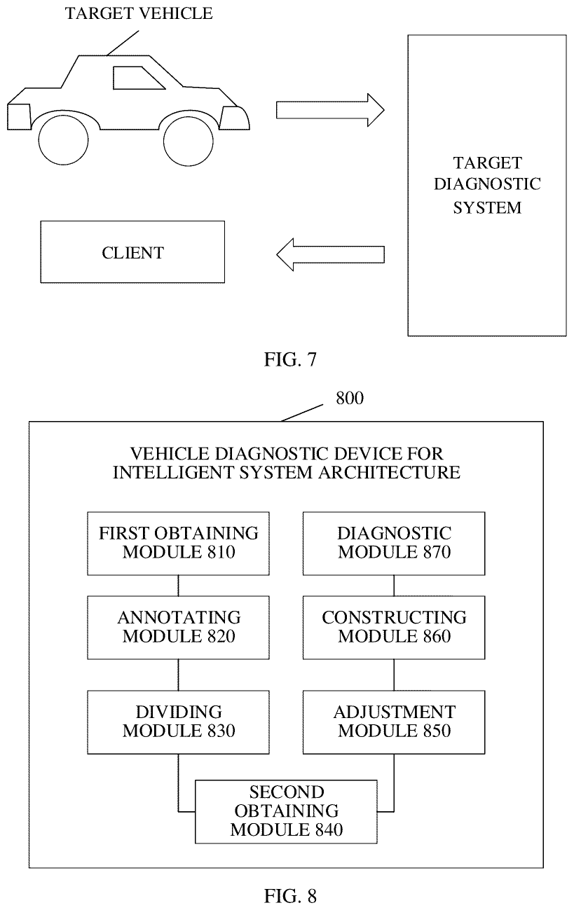

For ease of understanding, referring to FIG. 7, FIG. 7 is an architecture diagram of a vehicle diagnostic scenario provided in embodiments of the present application. It can be seen that after the target diagnostic system obtains the relevant data from the target vehicle, it processes the relevant data, and conducts in-depth analysis and reasoning on the processed data to obtain the target diagnostic result, and then feeds back the target diagnostic result to the client. The user can view through the client to clearly understand the diagnostic status of the target vehicle. The target diagnostic system can save and share the diagnostic result, which is convenient for communication and discussion with other professionals, and can also view historical diagnostic records, compare the status of the target vehicle in different periods, and better understand the health change trend of the target vehicle. The actual situation can be fed back to the target diagnostic system through the client, such as the effect after repair, so that the target diagnostic system can continuously optimize the diagnostic model and service quality.

The above mainly introduces the scheme of embodiments of the present application from the perspective of the execution process on the method side. It is understandable that, to achieve the above functions, the electronic device includes a hardware structure and/or software module corresponding to the execution of each function. It should be easily appreciated by those of ordinary skill in the art that, in combination with the units and algorithm steps of each example described in the embodiments provided herein, the present application can be implemented in the form of hardware or a combination of hardware and computer software. Whether a function is executed in the form of hardware or computer software driving hardware depends on the specific application and design constraints of the technical solution. Professional and technical personnel can use different methods to implement the described functions for each specific application, but such implementation should not be considered to be beyond the scope of the present application.

Embodiments of the present application can divide the electronic device into functional units according to the above method example. For example, each functional unit can be divided according to each function, or two or more functions can be integrated into one processing unit. The above integrated unit can be implemented in the form of hardware or in the form of software functional units. It should be noted that the division of units in embodiments of the present application is schematic and is only a logical function division. There may be other division methods in actual implementation.

In the case of dividing each functional module according to each function, FIG. 8 is a block diagram of functional modules of a vehicle diagnostic device for an intelligent system architecture provided in embodiments of the present application. The vehicle diagnostic device 800 for the intelligent system architecture includes a first obtaining module 810, an annotating module 820, a dividing module 830, a second obtaining module 840, an adjustment module 850, a constructing module 860, and a diagnostic module 870.

The first obtaining module 810 is configured to obtain a target diagnostic requirement and historical diagnostic data of a target vehicle; the annotating module 820 is configured to annotate the historical diagnostic data according to a preset dictionary format, to obtain reference data; the dividing module 830 is configured to divide, according to a preset ratio, the reference data into a training set and a validation set; the second obtaining module 840 is configured to obtain a pre-trained model and model feature information of the pre-trained model; the adjustment module 850 is configured to adjust the pre-trained model according to the target diagnostic requirement, the model feature information, the training set, and the validation set, to obtain a target model; the constructing module 860 is configured to perform system construction according to the target model, to obtain a target diagnostic system; and the diagnostic module 870 is configured to diagnose the target vehicle according to the target diagnostic system, to obtain a target diagnostic result.

Optionally, in terms of annotating the historical diagnostic data according to the preset dictionary format, to obtain the reference data, the annotating module 820 is configured to: determine first data and second data in the historical diagnostic data, where a data type of the first data is structured data and a data type of the second data is unstructured data; annotate the first data according to the preset dictionary format, to obtain first reference data; perform text extraction on the second data, to obtain a text content; integrate the text content, to obtain third data, where a data type of the third data is structured data; annotate the third data according to the preset dictionary format, to obtain second reference data; and determine the reference data according to the first reference data and the second reference data.

Optionally, in terms of adjusting the pre-trained model according to the target diagnostic requirement, the model feature information, the training set, and the validation set, to obtain the target model, the adjustment module 850 is configured to: determine an initial parameter according to the target diagnostic requirement and the model feature information; configure the pre-trained model according to the initial parameter, to obtain a first reference model; fine-tune the first reference model according to the training set, to obtain a second reference model; evaluate the second reference model according to the validation set, to obtain an evaluation result; and adjust the second reference model according to the evaluation result, to obtain the target model.

Optionally, in terms of determining the initial parameter according to the target diagnostic requirement and the model feature information, the adjustment module 850 is further configured to: determine a diagnostic task type and a diagnostic task difficulty that correspond to the target diagnostic requirement; determine a basic structure and an initial performance of the pre-trained model according to the model feature information; determine a part of structure corresponding to the diagnostic task type in the basic structure, to obtain a reference structure; determine a first parameter corresponding to the reference structure; determine a second parameter of the pre-trained model according to the diagnostic task difficulty and the initial performance; and determine the initial parameter according to the first parameter and the second parameter.

Optionally, in terms of the training set includes n training subsets, n being an integer greater than 1, and fine-tuning the first reference model according to the training set, to obtain the second reference model, the adjustment module 850 is further configured to: obtain a first training subset, where the first training subset is any one of the n training subsets; input the first training subset into the first reference model, to obtain a first output result; determine a first loss function according to the diagnostic task type; determine a first true result corresponding to the first output result; calculate a loss value between the first output result and the first true result according to the first loss function, to obtain a first loss value; determine a first gradient corresponding to the first loss value; adjust the initial parameter according to the first gradient, to obtain a first fine-tuning parameter; fine-tune the first reference model according to the first fine-tuning parameter, to obtain a first fine-tuned model; determine whether the first fine-tuned model meets a preset condition; when the first fine-tuned model meets the preset condition, determine the first fine-tuned model as the second reference model; and when the first fine-tuned model fails to meet the preset condition, fine-tune the first fine-tuned model according to (n-1) training subsets among the n training subsets except the first training subset, to obtain the second reference model.

Optionally, in terms of adjusting the second reference model according to the evaluation result, to obtain the target model, the adjustment module 850 is further configured to: determine an evaluation indicator and an evaluation value that correspond to the evaluation result; determine a reference value range and a third parameter that correspond to the evaluation indicator; when the evaluation value is within the reference value range, determine the second reference model as the target model; and when the evaluation value is beyond the reference value range, determine a maximum value and a minimum value of the reference value range; calculate a difference between the evaluation value and the maximum value or the minimum value, to obtain a first difference; determine an adjustment factor corresponding to the first difference; adjust the third parameter according to the adjustment factor, to obtain a fourth parameter; and adjust the second reference model according to the fourth parameter to obtain the target model.

Optionally, in terms of performing system construction according to the target model, to obtain the target diagnostic system, the constructing module 860 is configured to: determine a hardware facility corresponding to the target model; determine a deep learning framework compatible with the hardware facility; deploy the target model according to the deep learning framework, to obtain a large model layer; integrate the reference data, to obtain a data layer; obtain a cache layer, a startup layer, and a functional layer that are preset, where the cache layer is used to store cache information, the startup layer is used to provide a system interface, and the functional layer includes a user management module, a session management module, a knowledge base management module, a database management module, and a tool block management module; and perform system construction according to the large model layer, the data layer, the cache layer, the startup layer, and the functional layer, to obtain the target diagnostic system.

It can be seen that by making targeted adjustments to the pre-trained model and constructing the target diagnostic system, the vehicle can be diagnosed accurately and efficiently, reliable diagnostic results can be obtained, the intelligent and precise vehicle diagnosis can be achieved, the diagnostic cost can be reduced and the diagnostic efficiency can be improved.

It should be noted that the specific implementation of each operation can adopt the corresponding description of the method embodiment shown above, and the vehicle diagnostic device 800 for the intelligent system architecture can be used to execute the above method embodiment of the present application, which will not be repeated herein.

Embodiments of the present application also provide a computer-readable storage medium. The computer-readable storage medium stores a computer program for electronic data exchange, where the computer program causes a computer to execute part or all of the steps of any method recorded in the above method embodiments. The above computer includes an electronic device.

Embodiments of the present application also provide a computer program product. The computer program product includes a non-transitory computer-readable storage medium storing a computer program, where the computer program is operable to cause a computer to execute part or all of the steps of any method described in the method embodiment. The computer program product may be a software installation package, and the computer includes an electronic device.

It may be noted that, for the sake of brevity, the foregoing embodiments are described as a series of action combinations. However, it will be appreciated by those of ordinary skill in the art that the present application is not limited to the sequence of actions described. According to embodiments of the present application, some steps may be performed in other orders or simultaneously. In addition, it will be appreciated by those of ordinary skill in the art that the embodiments described in the specification are preferable embodiments, and the actions, steps, modules, or units involved are not necessarily essential to the present application.

In the foregoing embodiments, the elaboration of each embodiment has its own emphasis. For the parts not described in detail in one embodiment, reference can be made to related elaborations in other embodiments.

Those of ordinary skill in the art can understand that to implement all or part of the processes in the above-mentioned embodiments, the processes can be completed by instructing related hardware through computer programs, and the programs can be stored in the computer-readable storage medium. When executed, the programs can include the processes of the above-mentioned method embodiments. The aforementioned storage medium includes: ROM or random access memory (RAM), magnetic disk or optical disk, and other medium that can store program codes.

The operations of the method or algorithm described in embodiments of the present application may be implemented by means of hardware, or may be implemented by executing software instructions by a processor. The software instructions can be implemented by corresponding software modules, which can be stored in an RAM, a flash memory, an ROM, an EPROM, an electrically EPROM (EEPROM), registers, hard disk, mobile hard disk, compact disc (CD)-ROM, or any other form of storage medium known in the art. An exemplary storage medium is coupled to the processor, such that the processor can read information from the storage medium and write information to the storage medium. The storage medium can also be a component of the processor. The processor and the storage medium may be located in an ASIC. In addition, the ASIC can be located in a terminal device or a management device. The processor and the storage medium may also be present as discrete components in the terminal device or the management device.

Those of ordinary skill in the art will appreciate that, all or part of functions described in embodiments of the present application can be implemented through software, hardware, firmware, or any other combination thereof. When implemented by software, all or part of the functions can be implemented in the form of a computer program product. The computer program product includes one or more computer instructions. When the computer instructions are applied and executed on a computer, all or part of the operations or functions of embodiments of the present application are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner (e.g., a coaxial cable, an optical fiber, a digital subscriber line (DSL)) or in a wireless manner (e.g., infrared, wireless, microwave). The computer-readable storage medium can be any available medium accessed by the computer or be a data storage device such as a server or a data center that includes one or more available media. The available medium can be a magnetic medium (such as a soft disc, a hard disc, or a magnetic tape), an optical medium (such as a digital video disc (DVD)), or a semiconductor medium (such as a solid state disk (SSD)), etc.

Various modules/units in various devices or products described in the foregoing embodiments may be software modules/units or hardware modules/units, or some may be software modules/units and some may be hardware modules/units. For example, for various devices or products applied to or integrated into a chip, various modules/units included therein may all be achieved by means of hardware such as a circuit. Alternatively, at least some of the modules/units may be achieved by means of a software program, where the software program runs on a processor integrated into the chip, and the rest (if any) modules/units may be achieved by means of hardware such as a circuit. For various devices or products applied to or integrated into a chip module, various modules/units included therein may all be achieved by means of hardware such as a circuit, different modules/units may be located in the same component (e.g., chip, circuit module, etc.) or in different components of the chip module. Alternatively, at least some of the modules/units may be achieved by means of a software program, where the software program runs on a processor integrated into the chip module, and the rest (if any) modules/units may be achieved by means of hardware such as a circuit. For various devices or products applied to or integrated into a terminal device, various modules/units included therein may all be achieved by means of hardware such as a circuit, different modules/units may be located in the same component (e.g., chip, circuit module, etc.) or in different components of the terminal device. Alternatively, at least some of the modules/units may be achieved by means of a software program, where the software program runs on a processor integrated into the terminal device, and the rest (if any) modules/units may be achieved by means of hardware such as a circuit.

The objectives, technical solutions, and advantages of embodiments of the present application are described in detail in the foregoing implementations. It may be appreciated that, the foregoing elaborations are merely some implementations of embodiments of the present application, but are not intended to limit the protection scope of embodiments of the present application. Any modifications, equivalents, improvements, and the like made based on the technical solutions of embodiments of the present application shall all fall within the protection scope of embodiments of the present application.

What is claimed is:

1. A vehicle diagnostic method for an intelligent system architecture, comprising:
obtaining a target diagnostic requirement and historical diagnostic data of a target vehicle;
annotating the historical diagnostic data according to a preset dictionary format, to obtain reference data;
dividing, according to a preset ratio, the reference data into a training set and a validation set;
obtaining a pre-trained model and model feature information of the pre-trained model;
adjusting the pre-trained model according to the target diagnostic requirement, the model feature information, the training set, and the validation set, to obtain a target model;
performing system construction according to the target model, to obtain a target diagnostic system; and
diagnosing the target vehicle according to the target diagnostic system, to obtain a target diagnostic result.

2. The method of claim 1, wherein annotating the historical diagnostic data according to the preset dictionary format, to obtain the reference data comprises:
determining first data and second data in the historical diagnostic data, wherein a data type of the first data is structured data and a data type of the second data is unstructured data;
annotating the first data according to the preset dictionary format, to obtain first reference data;
performing text extraction on the second data, to obtain a text content;
integrating the text content, to obtain third data, wherein a data type of the third data is structured data;
annotating the third data according to the preset dictionary format, to obtain second reference data; and
determining the reference data according to the first reference data and the second reference data.

3. The method of claim 1, wherein adjusting the pre-trained model according to the target diagnostic requirement, the model feature information, the training set, and the validation set, to obtain the target model comprises:
determining an initial parameter according to the target diagnostic requirement and the model feature information;
configuring the pre-trained model according to the initial parameter, to obtain a first reference model;
fine-tuning the first reference model according to the training set, to obtain a second reference model;
evaluating the second reference model according to the validation set, to obtain an evaluation result; and
adjusting the second reference model according to the evaluation result, to obtain the target model.

4. The method of claim 3, wherein determining the initial parameter according to the target diagnostic requirement and the model feature information comprises:
determining a diagnostic task type and a diagnostic task difficulty that correspond to the target diagnostic requirement;
determining a basic structure and an initial performance of the pre-trained model according to the model feature information;
determining a part of structure corresponding to the diagnostic task type in the basic structure, to obtain a reference structure;
determining a first parameter corresponding to the reference structure;
determining a second parameter of the pre-trained model according to the diagnostic task difficulty and the initial performance; and
determining the initial parameter according to the first parameter and the second parameter.

5. The method of claim 4, wherein the training set comprises n training subsets, n being an integer greater than 1, and fine-tuning the first reference model according to the training set, to obtain the second reference model comprises:
obtaining a first training subset, wherein the first training subset is any one of the n training subsets;
inputting the first training subset into the first reference model, to obtain a first output result;
determining a first loss function according to the diagnostic task type;
determining a first true result corresponding to the first output result;
calculating a loss value between the first output result and the first true result according to the first loss function, to obtain a first loss value;
determining a first gradient corresponding to the first loss value;
adjusting the initial parameter according to the first gradient, to obtain a first fine-tuning parameter;
fine-tuning the first reference model according to the first fine-tuning parameter, to obtain a first fine-tuned model;
determining whether the first fine-tuned model meets a preset condition;
when the first fine-tuned model meets the preset condition, determining the first fine-tuned model as the second reference model; and
when the first fine-tuned model fails to meet the preset condition, fine-tuning the first fine-tuned model according to (n-1) training subsets among the n training subsets except the first training subset, to obtain the second reference model.

6. The method of claim 3, wherein adjusting the second reference model according to the evaluation result, to obtain the target model comprises:
determining an evaluation indicator and an evaluation value that correspond to the evaluation result;
determining a reference value range and a third parameter that correspond to the evaluation indicator;
when the evaluation value is within the reference value range, determining the second reference model as the target model; and
when the evaluation value is beyond the reference value range,
determining a maximum value and a minimum value of the reference value range;
calculating a difference between the evaluation value and the maximum value or the minimum value, to obtain a first difference;
determining an adjustment factor corresponding to the first difference;
adjusting the third parameter according to the adjustment factor, to obtain a fourth parameter; and
adjusting the second reference model according to the fourth parameter to obtain the target model.

7. The method of claim 1, wherein performing system construction according to the target model, to obtain the target diagnostic system comprises:
determining a hardware facility corresponding to the target model;
determining a deep learning framework compatible with the hardware facility;
deploying the target model according to the deep learning framework, to obtain a large model layer;
integrating the reference data, to obtain a data layer;
obtaining a cache layer, a startup layer, and a functional layer that are preset, wherein the cache layer is used to store cache information, the startup layer is used to provide a system interface, and the functional layer comprises a user management module, a session management module, a knowledge base management module, a database management module, and a tool block management module; and
performing system construction according to the large model layer, the data layer, the cache layer, the startup layer, and the functional layer, to obtain the target diagnostic system.

8. An electronic device, comprising:
at least one processor; and
a memory coupled to the at least one processor and storing at least one computer executable instruction thereon which, when executed by the at least one processor, causes the at least one processor to:
obtain a target diagnostic requirement and historical diagnostic data of a target vehicle;
annotate the historical diagnostic data according to a preset dictionary format, to obtain reference data;
divide, according to a preset ratio, the reference data into a training set and a validation set;
obtain a pre-trained model and model feature information of the pre-trained model;
adjust the pre-trained model according to the target diagnostic requirement, the model feature information, the training set, and the validation set, to obtain a target model;
perform system construction according to the target model, to obtain a target diagnostic system; and
diagnose the target vehicle according to the target diagnostic system, to obtain a target diagnostic result.

9. The electronic device of claim 8, wherein to annotate the historical diagnostic data according to the preset dictionary format, to obtain the reference data, the at least one computer executable instruction, when executed by the at least one processor, causes the at least one processor to:
determine first data and second data in the historical diagnostic data, wherein a data type of the first data is structured data and a data type of the second data is unstructured data;
annotate the first data according to the preset dictionary format, to obtain first reference data;
perform text extraction on the second data, to obtain a text content;
integrate the text content, to obtain third data, wherein a data type of the third data is structured data;
annotate the third data according to the preset dictionary format, to obtain second reference data; and
determine the reference data according to the first reference data and the second reference data.

10. The electronic device of claim 8, wherein to adjust the pre-trained model according to the target diagnostic requirement, the model feature information, the training set, and the validation set, to obtain the target model, the at least one computer executable instruction, when executed by the at least one processor, causes the at least one processor to:
determine an initial parameter according to the target diagnostic requirement and the model feature information;
configure the pre-trained model according to the initial parameter, to obtain a first reference model;
fine-tune the first reference model according to the training set, to obtain a second reference model;
evaluate the second reference model according to the validation set, to obtain an evaluation result; and
adjust the second reference model according to the evaluation result, to obtain the target model.

11. The electronic device of claim 10, wherein to determine the initial parameter according to the target diagnostic requirement and the model feature information, the at least one computer executable instruction, when executed by the at least one processor, causes the at least one processor to:
determine a diagnostic task type and a diagnostic task difficulty that correspond to the target diagnostic requirement;
determine a basic structure and an initial performance of the pre-trained model according to the model feature information;
determine a part of structure corresponding to the diagnostic task type in the basic structure, to obtain a reference structure;
determine a first parameter corresponding to the reference structure;
determine a second parameter of the pre-trained model according to the diagnostic task difficulty and the initial performance; and
determine the initial parameter according to the first parameter and the second parameter.

12. The electronic device of claim 11, wherein the training set comprises n training subsets, n being an integer greater than 1, and wherein to fine-tune the first reference model according to the training set, to obtain the second reference model, the at least one computer executable instruction, when executed by the at least one processor, causes the at least one processor to:
obtain a first training subset, wherein the first training subset is any one of the n training subsets;
input the first training subset into the first reference model, to obtain a first output result;
determine a first loss function according to the diagnostic task type;
determine a first true result corresponding to the first output result;
calculate a loss value between the first output result and the first true result according to the first loss function, to obtain a first loss value;
determine a first gradient corresponding to the first loss value;
adjust the initial parameter according to the first gradient, to obtain a first fine-tuning parameter;
fine-tune the first reference model according to the first fine-tuning parameter, to obtain a first fine-tuned model;
determine whether the first fine-tuned model meets a preset condition;
when the first fine-tuned model meets the preset condition, determining the first fine-tuned model as the second reference model; and
when the first fine-tuned model fails to meet the preset condition, fine-tune the first fine-tuned model according to (n-1) training subsets among the n training subsets except the first training subset, to obtain the second reference model.

13. The electronic device of claim 10, wherein to adjust the second reference model according to the evaluation result, to obtain the target model, the at least one computer executable instruction, when executed by the at least one processor, causes the at least one processor to:
determine an evaluation indicator and an evaluation value that correspond to the evaluation result;
determine a reference value range and a third parameter that correspond to the evaluation indicator;
when the evaluation value is within the reference value range, determine the second reference model as the target model; and
when the evaluation value is beyond the reference value range,
determine a maximum value and a minimum value of the reference value range;
calculate a difference between the evaluation value and the maximum value or the minimum value, to obtain a first difference;
determine an adjustment factor corresponding to the first difference;
adjust the third parameter according to the adjustment factor, to obtain a fourth parameter; and
adjust the second reference model according to the fourth parameter to obtain the target model.

14. The electronic device of claim 8, wherein to perform system construction according to the target model, to obtain the target diagnostic system, the at least one computer executable instruction, when executed by the at least one processor, causes the at least one processor to:
determine a hardware facility corresponding to the target model;
determine a deep learning framework compatible with the hardware facility;
deploy the target model according to the deep learning framework, to obtain a large model layer;
integrate the reference data, to obtain a data layer;
obtain a cache layer, a startup layer, and a functional layer that are preset, wherein the cache layer is used to store cache information, the startup layer is used to provide a system interface, and the functional layer comprises a user management module, a session management module, a knowledge base management module, a database management module, and a tool block management module; and
perform system construction according to the large model layer, the data layer, the cache layer, the startup layer, and the functional layer, to obtain the target diagnostic system.

15. A non-transitory computer-readable storage medium storing a computer program, wherein the computer program comprises program instructions which, when executed by a processor, cause the processor to execute:
obtaining a target diagnostic requirement and historical diagnostic data of a target vehicle;
annotating the historical diagnostic data according to a preset dictionary format, to obtain reference data;
dividing, according to a preset ratio, the reference data into a training set and a validation set;
obtaining a pre-trained model and model feature information of the pre-trained model;
adjusting the pre-trained model according to the target diagnostic requirement, the model feature information, the training set, and the validation set, to obtain a target model;
performing system construction according to the target model, to obtain a target diagnostic system; and
diagnosing the target vehicle according to the target diagnostic system, to obtain a target diagnostic result.

16. The non-transitory computer-readable storage medium of claim 15, wherein annotating the historical diagnostic data according to the preset dictionary format, to obtain the reference data comprises:
determining first data and second data in the historical diagnostic data, wherein a data type of the first data is structured data and a data type of the second data is unstructured data;
annotating the first data according to the preset dictionary format, to obtain first reference data;
performing text extraction on the second data, to obtain a text content;
integrating the text content, to obtain third data, wherein a data type of the third data is structured data;
annotating the third data according to the preset dictionary format, to obtain second reference data; and
determining the reference data according to the first reference data and the second reference data.

17. The non-transitory computer-readable storage medium of claim 15, wherein adjusting the pre-trained model according to the target diagnostic requirement, the model feature information, the training set, and the validation set, to obtain the target model comprises:
determining an initial parameter according to the target diagnostic requirement and the model feature information;
configuring the pre-trained model according to the initial parameter, to obtain a first reference model;
fine-tuning the first reference model according to the training set, to obtain a second reference model;
evaluating the second reference model according to the validation set, to obtain an evaluation result; and
adjusting the second reference model according to the evaluation result, to obtain the target model.

18. The non-transitory computer-readable storage medium of claim 17, wherein determining the initial parameter according to the target diagnostic requirement and the model feature information comprises:
determining a diagnostic task type and a diagnostic task difficulty that correspond to the target diagnostic requirement;
determining a basic structure and an initial performance of the pre-trained model according to the model feature information;
determining a part of structure corresponding to the diagnostic task type in the basic structure, to obtain a reference structure;
determining a first parameter corresponding to the reference structure;
determining a second parameter of the pre-trained model according to the diagnostic task difficulty and the initial performance; and
determining the initial parameter according to the first parameter and the second parameter.

19. The non-transitory computer-readable storage medium of claim 18, wherein the training set comprises n training subsets, n being an integer greater than 1, and fine-tuning the first reference model according to the training set, to obtain the second reference model comprises:
obtaining a first training subset, wherein the first training subset is any one of the n training subsets;
inputting the first training subset into the first reference model, to obtain a first output result;
determining a first loss function according to the diagnostic task type;
determining a first true result corresponding to the first output result;
calculating a loss value between the first output result and the first true result according to the first loss function, to obtain a first loss value;
determining a first gradient corresponding to the first loss value;
adjusting the initial parameter according to the first gradient, to obtain a first fine-tuning parameter;
fine-tuning the first reference model according to the first fine-tuning parameter, to obtain a first fine-tuned model;
determining whether the first fine-tuned model meets a preset condition;
when the first fine-tuned model meets the preset condition, determining the first fine-tuned model as the second reference model; and
when the first fine-tuned model fails to meet the preset condition, fine-tuning the first fine-tuned model according to (n-1) training subsets among the n training subsets except the first training subset, to obtain the second reference model.

20. The non-transitory computer-readable storage medium of claim 17, wherein adjusting the second reference model according to the evaluation result, to obtain the target model comprises:
determining an evaluation indicator and an evaluation value that correspond to the evaluation result;
determining a reference value range and a third parameter that correspond to the evaluation indicator;
when the evaluation value is within the reference value range, determining the second reference model as the target model; and
when the evaluation value is beyond the reference value range,
determining a maximum value and a minimum value of the reference value range;
calculating a difference between the evaluation value and the maximum value or the minimum value, to obtain a first difference;
determining an adjustment factor corresponding to the first difference;
adjusting the third parameter according to the adjustment factor, to obtain a fourth parameter; and
adjusting the second reference model according to the fourth parameter to obtain the target model.
